(19) United States
(12) Patent Application Publication
(10) Pub. No.: US 2002/0071597 A1
(43) Pub. Date: Jun. 13, 2002

(54) System and method for fitting shoes

(76) Inventors: Marjorie C. Ravitz, St. James, NY (US); Pasquale J. Amendolia, St. James, NY (US)

Correspondence Address: Ira J. Schaefer, Esq., Clifford Chance Rogers & Wells LLP, 200 Park Avenue, New York, NY, 10166, US

(21) Appl. No.: 09/736,057

(22) Filed: Dec. 13, 2000

(51) Int. Cl. G06K 9/00; G06K 9/36

(52) U.S. Cl. 382/111; 382/286

(57) ABSTRACT

A method for fitting shoes comprises maintaining an inventory of shoes of different styles and sizes, wherein each shoe has a flat inner foot receiving surface and measuring the size, width and arch height of feet of a customer to be fitted for shoes. The proper size shoes of at least one style selected by the customer is selected and an orthotic is inserted onto the flat inner foot receiving surface of each of the selected shoes. The combination of the orthotic and the shoe is fitted on the feet of the customer.

### BACKGROUND OF THE INVENTION

The present invention relates to a method and system for fitting shoes, and in particular, to the use of orthotics with shoes to insure a good fit for dress or fashion shoes.

Many people suffer from foot problems, primarily because they wear shoes that do not fit well. Most shoes are mass produced and are not made to fit a particular foot. Moreover, while men's shoes come in different sizes and widths, women's fashion shoes do not come in width sizes, but only come in length sizes and therefore magnify the fit problem.

One solution to improve the fit of mass produced shoes is to have a podiatrist measure your feet and custom make orthotics for you. However, the podiatrist does not make the orthotic for a particular shoe, and the orthotic may not interact well when placed in a mass produced shoe, particularly fashion shoes, and most particularly women's fashion shoes.

Some shoes, particularly specially made shoes, such as ski boots and what are known as orthopedic shoes, use custom made orthotics. These are generally bulky, non-fashionable shoes. There are some retailers that will make the orthotic for a customer at the store. The custom made orthotic generally takes fifteen minutes or more to construct and is made to fit into this special type of bulky shoe. This system has the disadvantage that many people do not want to wait the fifteen minutes or more that is necessary to produce the orthotic, and more importantly, many consumers desire a fashion or dress shoe that they want to choose from a selection of styles.

Retailers have developed custom made orthotics for ski boots, because these boots are worn over and over again and an ill fitting ski boot subjects the user's foot to considerable pain because of the stresses exerted on the foot while in use. Heretofore, no one has thought to use custom orthotics in fashion shoes, particularly for women, because these shoes are worn infrequently, and women are apparently willing to put up with the pain so that their shoes can be fashionable. Moreover, the shoe structure of fashion shoes makes them more difficult to use with orthotics than bulky ski boots or orthopedic shoes.

While there are many off the shelf orthotics that are available, these also are not made to fit a particular shoe and generally do not have sufficient size variations to solve most foot problems.

While the prior art teaches devices for measuring the feet such as in U.S. Pat. Nos. 5,822,223, 6,006,412, 5,879,725, 6,029,358, 5,790,256, and 5,671,055, and improved orthotics in U.S. Pat. Nos. 5,373,650, 5,958,546, 6,042,759, 4,446,856 and 4,628,936, none teach the combination of an orthotic matched to a fashion shoe and particularly to a women's fashion shoe.

It is therefore desirable to have a method and a system for fitting shoes wherein the orthotic is matched to the shoes, and in particular, to fashion shoes, and more particularly, to women's fashion shoes. In this way, the consumer can have both a proper fitting shoe and a stylish shoe.

### SUMMARY OF THE INVENTION

The main object of the present invention is to provide a method and system for fitting shoes, so that mass produced shoes can be closely matched to each person's foot for a good fit.

A further object of the present invention is to provide a combination of shoe and orthotic that has both medical efficacy and good appearance.

A still further object of the present invention is to provide specially made, although not custom made, shoes that interact particularly well with orthotics to provide a good fit in a fashion shoe.

Another object of the present invention is to provide a simple, inexpensive device and method for measuring foot size and arch height to enable the use of mass produced orthotics to closely match the size of a foot so as to enable the selection of a proper orthotic.

These and other objects and advantages of the present invention are achieved in accordance with the present invention by a method and system for fitting shoes in accordance with the present invention.

In accordance with a method for fitting shoes according to the present invention, an inventory of shoes of different styles and sizes is maintained, each shoe having a flat inner foot receiving or bottom surface. The shoes are preferably dress shoes or fashionable shoes, meaning that they exclude sneakers and molded orthopedic shoes.

The size, width and arch height of the feet of a customer to be fitted for shoes are measured. Preferably, the measurement is carried out by a device in accordance with the present invention which has a surface for receiving a foot and reference indicia thereon to indicate the size of the foot, the width of the foot, preferably being one of three different widths, as opposed to the traditional width measuring system, and a mechanism for measuring the arch height of the foot. Preferably, the arch height of the foot is indicated by one of three different arch heights. Alternatively, the feet can be measured using prior art devices such as those disclosed for example in U.S. Pat. Nos. 5,822,223, 6,006,412, 5,879,725, 6,029,358, 5,790,256, and 5,671,055, the disclosures of which are hereby incorporated by reference.

After the feet are measured, the proper size shoes of at least one style selected by the customer is selected and an orthotic is inserted onto the flat inner foot receiving surface of each of the selected shoes. The orthotics may be prefabricated orthotics, prescription orthotics supplied by the customer or custom made orthotics fabricated in advance or on the premises for the customer. The orthotic can be the one's described hereinafter or be ones which described in the aforementioned patents and U.S. Pat. Nos. 5,373,650, 5,958,546, 6,042,759, 4,446,856 and 4,628,936, the disclosures of which are hereby incorporated by reference. The combination of the orthotics and the shoes are then fitted on the feet of the customer at the retailer.

The invention is also directed to a system for carrying out the method set forth hereinabove.

These and other features and advantages of the present invention will become more apparent from the following detailed description of the preferred embodiments and the attached drawings, wherein:

### BRIEF DESCRIPTION OF THE DRAWINGS

FIG. 1 is a block diagram of the system according to the invention;

FIG. 2 is a flow chart of the method according to the present invention;

FIG. 3 is a perspective view of a device for measuring feet in accordance with the present invention;

FIG. 3A is a top view of the indicia used in the device of FIG. 3;

FIG. 4 is a top view of the device of FIG. 3;

FIG. 5 is a view of one end of the device of FIG. 3;

FIG. 6 is a view of the other end of the device of FIG. 3;

FIG. 7 is a sectional view of an alternative embodiment of a device for measuring feet;

FIG. 8 is a block diagram of the circuitry of the embodiment of FIG. 7;

FIG. 9 is a top view of an orthotic useable in the method according to the present invention; and

FIG. 10 is a sectional view of the orthotic of FIG. 9.

### DETAILED DESCRIPTION OF THE INVENTION

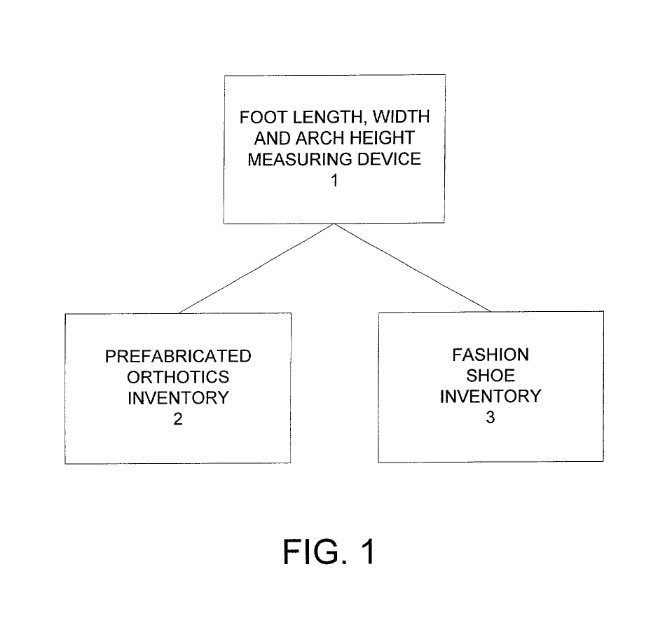

FIG. 1 shows the elements of the system according to the present invention for carrying out the method of the present invention.

In accordance with the present invention, the system includes a foot length, width and arch height measuring device 1 which obtains the measurements necessary to select the proper size shoe selected from the fashion shoe inventory 3 based upon a style selection made by the customer and to select the proper prefabricated orthotic from the prefabricated orthotic inventory 2 which has different sizes and arch heights.

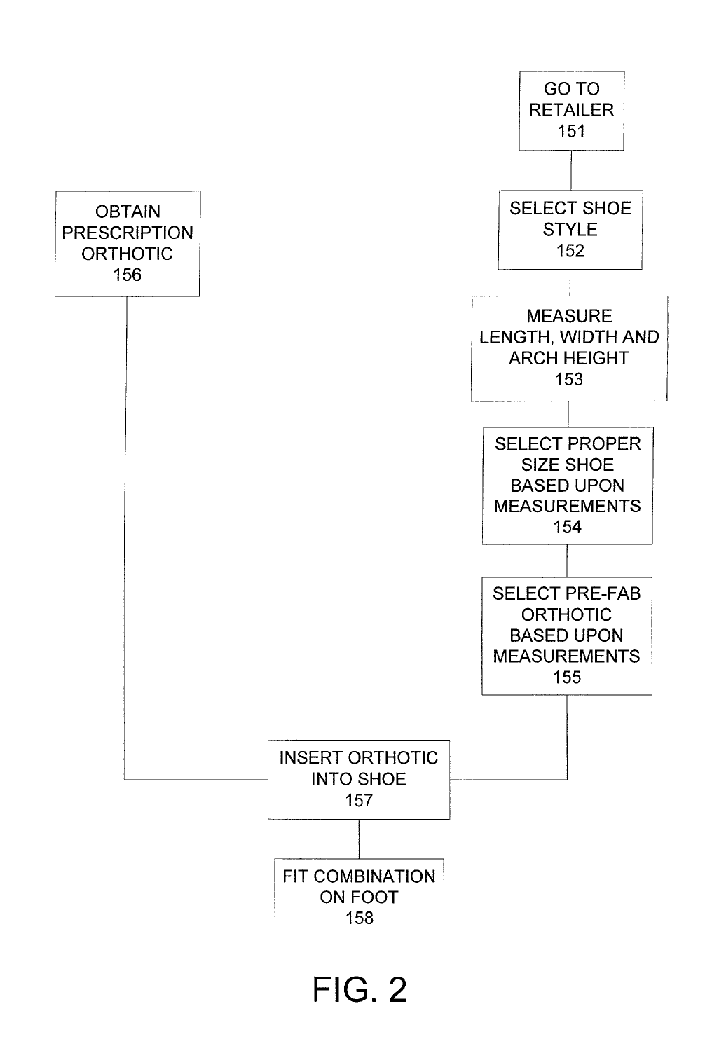

FIG. 2 shows the method according to the present invention utilizing the system of FIG. 1.

In accordance with the present invention, a customer goes to a retailer in step 151 and selects a shoe style in step 152. The retailer then measures the length, width and arch height of the customer's feet in step 153. It is clear that step 153 can take place prior to the collection of the shoe style in 152.

Based upon the measurements, the proper shoe size is selected and the proper prefabricated orthotic is selected in step 154 and 155. Clearly, the order of these steps can be reversed.

Alternatively, a customer may have obtained a prescription orthotic in step 156 by going to a podiatrist or other provider, wherein the foot was measured and a custom made orthotic was constructed. In step 157, either the orthotic obtained by the prescription or the prefabricated orthotic that comes from the inventory is inserted into a shoe in step 157 and the combination is fitted on the foot in step 158.

In accordance with the present invention, it should be clear that many of the steps of the present invention can be carried out over the Internet. For example, rather than going to a retailer, the shoe style can be selected over the Internet. Moreover, the customer can provide the length, width and arch height measurements over the Internet so that the selection of the proper shoe size and prefabricated orthotic can be carried out and the combination can be provided to the customer via courier or the mails. The insertion of the orthotic into the shoe and/or the fitting of the combination on the foot can then take place at the customer's residence or the like. Alternatively, the shoe and orthotic can be ordered over the Internet and tried on and purchased at a retail store.

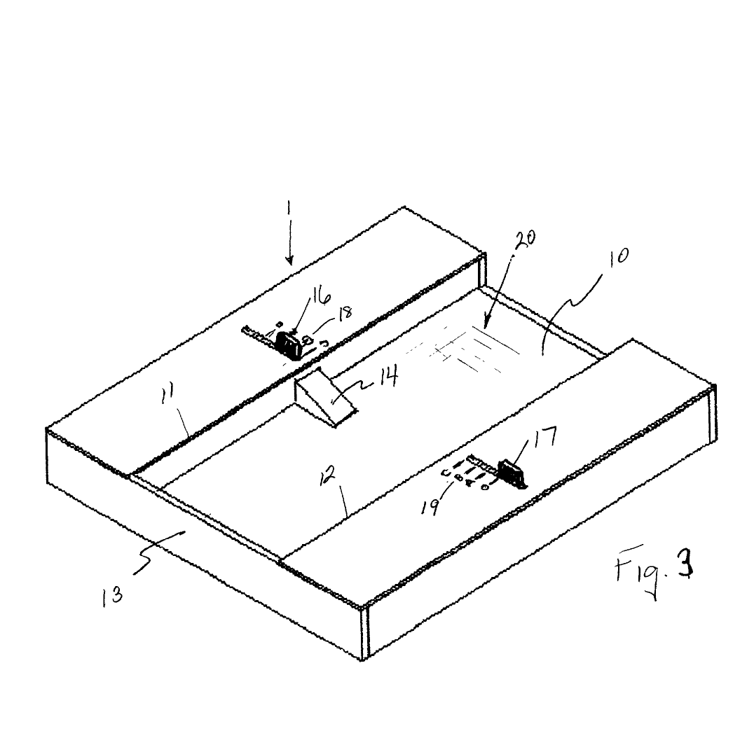

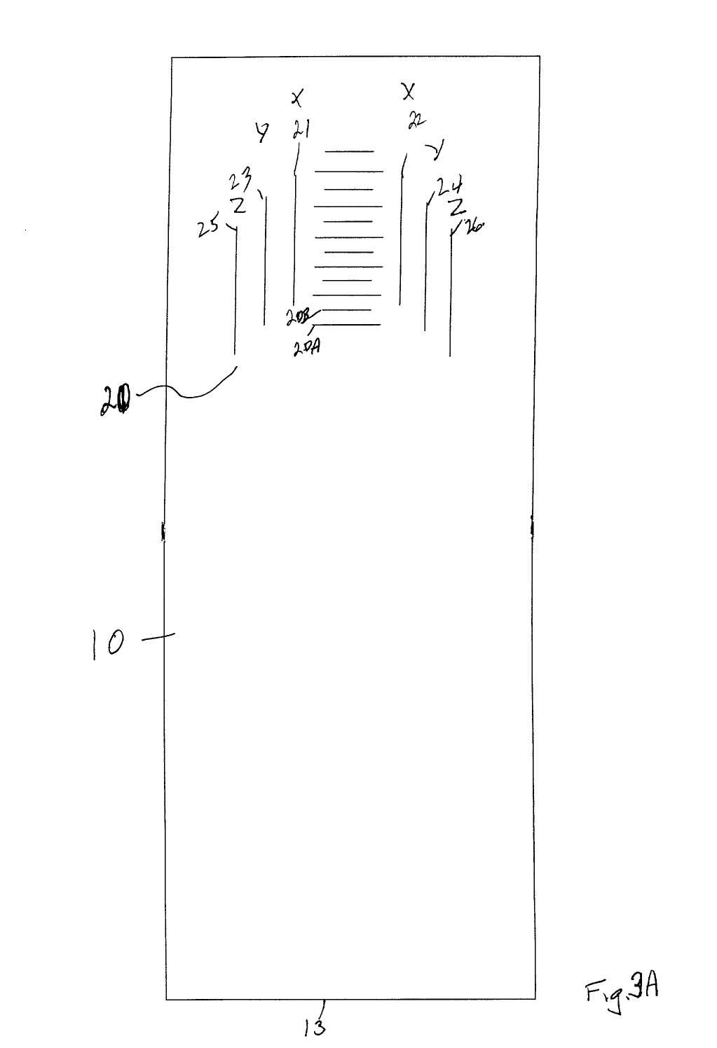

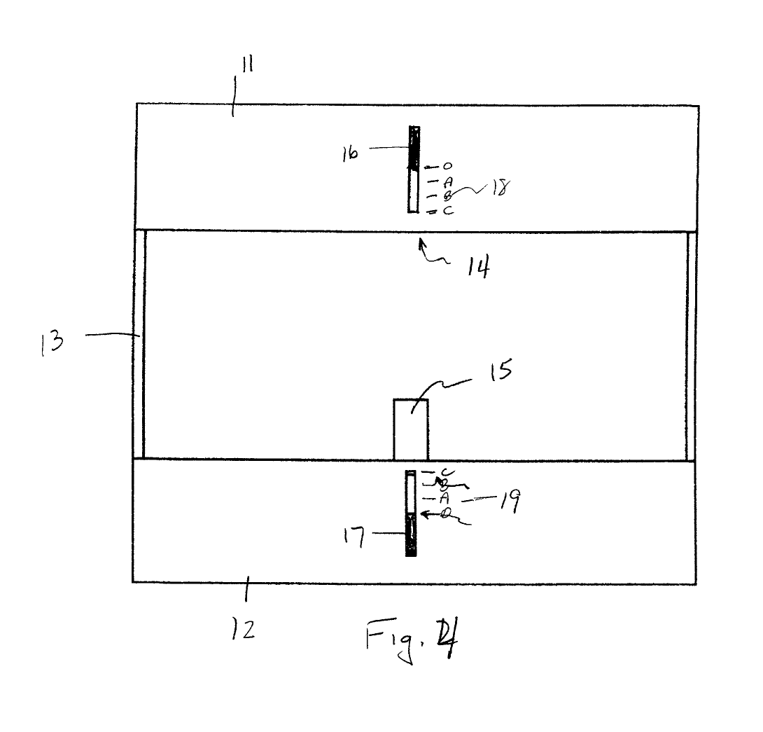

Referring now to FIGS. 3-6, a first embodiment of a device for measuring feet for use in the system and the method of the present invention is described.

The device 1 comprises a box having a top surface 10 on which measurement indicia 20 are laid out relative to a heel stop 13 against which the heel of the foot being measured is placed. The measurement indicia shown in FIG. 3A include a set of lines 21-26 for measuring the width of each foot, instead of line 20A, 20B for measuring the length of the foot.

The length measuring lines 20A, 20B include full size lines 20A and half size lines 20B which are standard measurement lines for measuring lengths of a foot of either children or adults with a full range of shoe sizes relative to the heel stop surface 13.

In order to measure the width of a foot, the width measuring indicia 21-26 are used, with indicia 21 and 22 corresponding to width X, indicia 23 and 24 corresponding to width Y and indicia 25 and 26 corresponding to width Z. Alternatively, the lines can be replaced with colored bands, with associated bands for X being the same color, for Y being the same color and for Z being the same color. The right foot is placed on surface 10 with the heel against heel stop 13 and the foot is centered between lines 21 and 22, 23 and 24 or 26 and 26, depending on the width of the foot. If the foot is between lines 21 and 22, the width is X, if between 23 and 24, the width is Y and between 25 and 26, the width is Z. For example, X width is 4 inches, Y width is 4.5 inches and Z width is 5 inches.

In order to measure the arch height of each foot, the mechanism including elements 14-19 are utilized. For example, in order to measure the arch height of the right foot, after the right foot width is measured, the arch of the right foot is centered at tab 16 with wedge 14 fully retracted (in the manner in which wedge 15 is fully retracted in the embodiment of FIG. 3). The right foot is place firmly against the left stop surface 11. Thereafter, tab 16 is moved toward the right until the wedge 14 can no longer move inwardly under the arch of the right foot. At that point, the leading edge of the tab 16 will be opposite a particular line of indicia 18. Indicia 18 includes a mark N“0” for the fully retracted position as shown in FIG. 2 with regard to wedge 14 or indicia marking C for the fully extended position of the wedge as shown, for example, with regard to FIG. 2. Between the fully extended and fully retracted positions are indicia marks A and B. Thus, arch heights are expressed in terms of arch heights A, B and C in accordance with the system of the present invention. For example, A height is 1 mm, B height is 1.5 mm and C height is 2.0 mm.

The measurement of the arch height of the left foot is carried out using wedge 15 controlled by tab 17 and marked with indicia 19 and right stop surface 12.

The length, width and arch height information obtained from the measuring device can then be used to select orthotics, for example, those kept in inventory for different sizes and arch heights, or which can be fabricated from the measurements and custom made for the customer.

When the device is used for sizing children's feet, the device can have colorful lights and/or decorations to make it more friendly to the children.

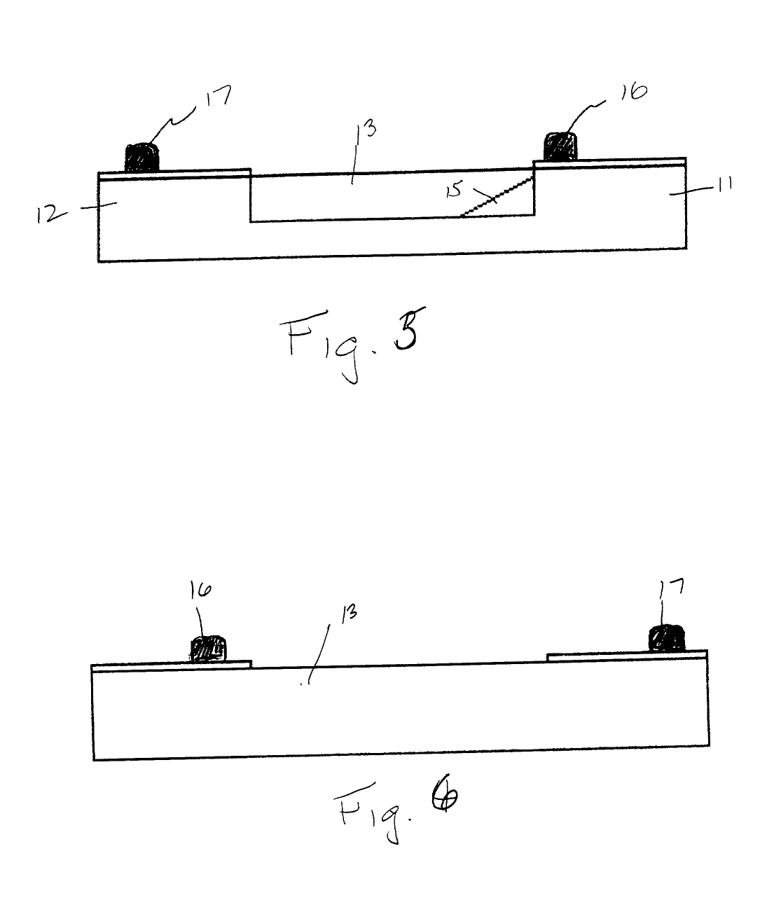

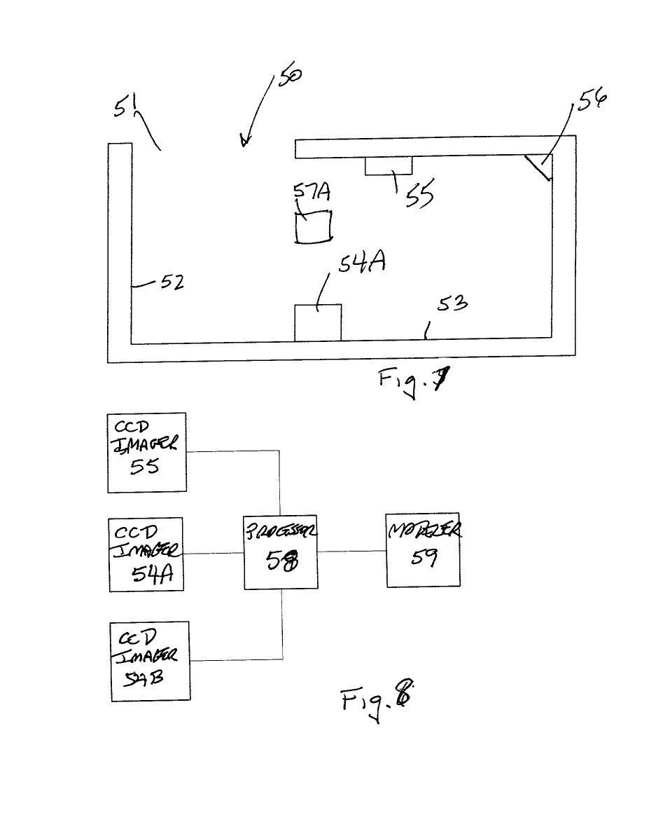

FIGS. 7 and 8 show an alternative embodiment of a foot measuring device according to the present invention.

In the embodiment of FIGS. 7 and 8, the measurement of the length, width and arch height of the foot is carried out by imaging devices, rather than by mechanical means. Specifically, box 50 is provided in which the foot that is to be measured is placed. In this instance, the rear wall 52 of the box provides the reference measurement line for the back of the foot, and the side walls of the box on the right and left sides provide the reference marks corresponding to lines 22 and 23 in the embodiment shown in FIG. 3A. Indicia is contained on the bottom wall 53 of the box corresponding to lines 20A, 20B and 21-26 to provide the length and width measurements. The measurements are recorded by CCD imagers 55 and 54A and 54B which are disposed at locations around the box, so that the relative position of the foot with respect to the measuring indicia can be viewed thereby with the aid of illuminating lights 57A, 57B and 56. The height of the arch is determined by the CCD imagers 54A and 54B which are on opposite sides of the box at the level of the surface 53 and which can record the image of the arch height.

The outputs of the imagers 54A, 54B and 55 are applied to a processor 58 which performs image processing on the images to determine the length, width and arch height of the foot. In a preferred embodiment of the present invention, the output of the processor can be fed to a modeler 59 which can create orthotics specifically for the measured foot from the data input by the imagers.

Alternatively, the foot size can be measured remotely by other sensors, such as ultrasonic sensors, laser sensors and proximity sensors, as long as the accuracy is sufficiently within the ranges of length, width and arch height described above.

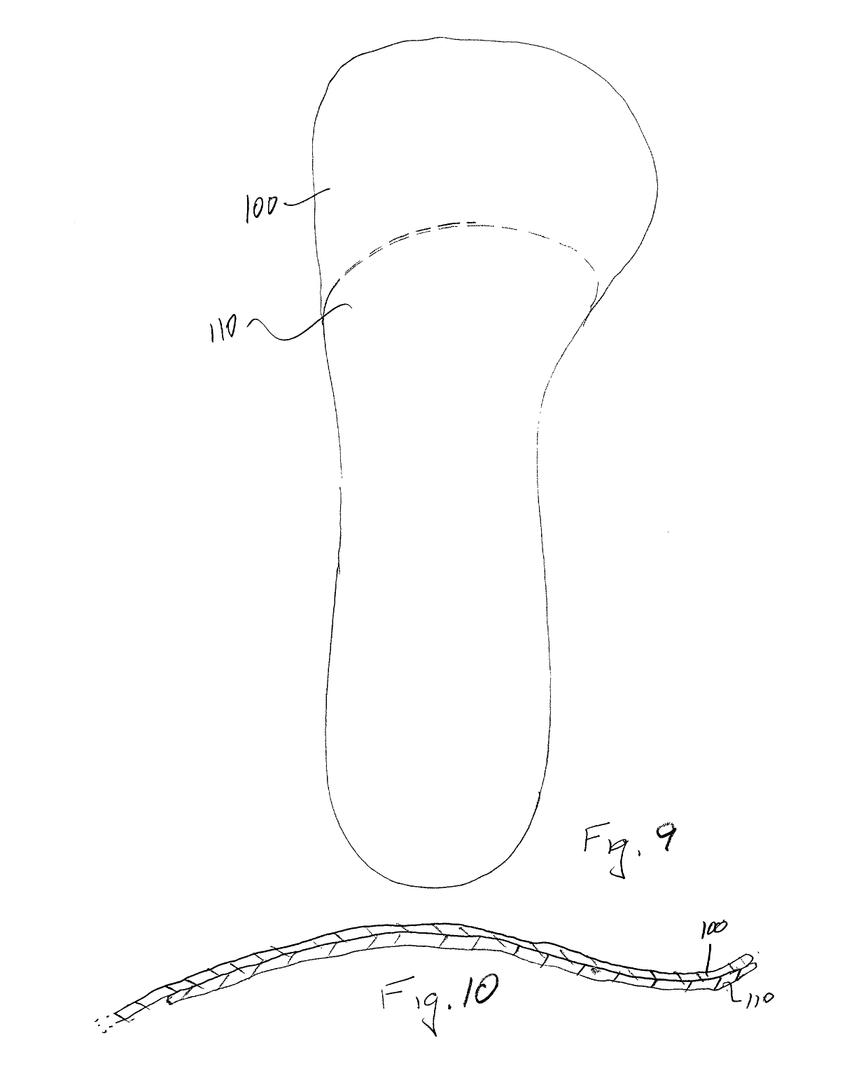

Once the customer's foot size is measured, an orthotic selected for that customer is placed on the flat bottom foot receiving surface of the shoe. The shoes kept in the inventory in accordance with the method and system of the present invention have all arch support or otherwise normally provided cushioning removed so that the foot receiving surface is flat. FIGS. 9 and 10 show a custom made orthotic formed from the measurements taken, as described hereinabove, for use in accordance with the method and system of the present invention.

The orthotic includes a top cover 100 and a substantially rigid shell 110 disposed thereunder. The shell is formed to the width and arch height of the measured feet.

As shown in FIG. 10, the top layer 100 is disposed on top of the layer 110 and is glued on by an adhesive. The top layer is preferably PPD and the shell is formed from carbon graphite plastic.

The orthotics used in accordance with the present invention can be prefabricated orthotics made by Sorbathane, Spenco or Dr. Scholl's, for example.

It is understood that the embodiment described hereinabove are merely illustrative and are not intended to limit the scope of the invention. It is realized that various changes, alterations, rearrangements and modifications can be made those skilled in the art without substantially departing from the spirit and scope of the present invention.

What is claimed is:

1. A method for fitting shoes, comprising the steps of:
maintaining an inventory of shoes of different styles and sizes, each shoe having a flat inner foot receiving surface;
measuring the size, width and arch height of feet of a customer to be fitted for shoes;
selecting the proper size shoes of at least one style selected by the customer;
inserting an orthotic onto the flat inner foot receiving surface of each of the selected shoes; and
fitting the combination of the orthotic and the shoe on the feet of the customer.

2. The method according to claim 1, wherein the orthotic is a prefabricated orthotic.

3. The method according to claim 2, further comprising maintaining an inventory of orthotics having a range of sizes.

4. The method according to claim 1, wherein the orthotic is a custom made orthotic.

5. The method according to claim 4, further comprising fabricating the custom made orthotic from the measurements of the size, width and arch height for each foot.

6. The method according to claim 1, wherein the orthotic is a prescription orthotic.

7. The method according to claim 1, wherein the inventory of shoes comprises dress shoes.

8. The method according to claim 1, wherein the inventory of shoes comprises fashion shoes.

9. The method according to claim 8, wherein the inventory of shoes comprises women's fashion shoes.

10. The method according to claim 1, wherein the step of measuring the width includes measuring one of three foot widths for each foot.

11. The method according to claim 1, wherein the style of the shoe is selected over the Internet.

12. A system for fitting shoes, comprising:
an inventory of shoes of different styles and sizes, each shoe having a flat inner foot receiving surface;
a device for measuring the size, width and arch height of feet of a customer to be fitted for shoes; and
an inventory of prefabricated orthotics for inserting onto the flat inner foot receiving surface of each of proper size shoes of at least one style selected by the customer, the orthotic selected from the inventory of orthotics based upon the measurements;
whereby the combination of the selected orthotics and the selected shoes are fitted on the feet of the customer.

13. The system according to claim 12, wherein the inventory of prefabricated orthotics have a range of sizes and arch heights.

14. The system according to claim 12, wherein the device for measuring the width includes indicia for measuring one of three foot widths for each foot.

15. A system for fitting shoes, comprising:
an inventory of shoes of different styles and sizes, each shoe having a flat inner foot receiving surface;
a device for measuring the size, width and arch height of feet of a customer to be fitted for shoes; and
a custom made orthotic for inserting onto the flat inner foot receiving surface of each of proper size shoes of at least one style selected by the customer;
whereby the combination of the orthotics and the selected shoes are fitted on the feet of the customer.

16. The system according to claim 15, further comprising a device for fabricating the custom made orthotic from the measurements of the size, width and arch height for each foot.

17. The system according to claim 15, wherein the orthotic is a prescription orthotic.

18. The system according to claim 15, wherein the inventory of shoes comprises dress shoes.

19. The system according to claim 15, wherein the inventory of shoes comprises fashion shoes.

20. The system according to claim 19, wherein the fashion shoes are women's fashion shoes.

21. The system according to claim 15, wherein the device for measuring the width includes indicia for measuring one of three foot widths for each foot.

22. A device for measuring foot size comprising:
a surface for receiving a foot;
a first reference on the surface for indicating a selected location of the back of a foot:
a second reference on the surface for indicating a selected location for one side of the right foot;
a third reference on the surface for indicating a selected location for one side of the left foot;
first indicia on the surface for indicating the length of a foot having the back of the foot at the first reference;
second indicia on the surface for indicating the width of the right foot having the one side thereof at the second reference;
third indicia on the surface for indicating the width of the left foot having the one side thereof at the third reference; and
a mechanism for measuring the height of the arch of the left foot and the right foot.

23. The device according to claim 22, wherein the second and third indicia each comprise three parallel lines.

24. The device according to claim 22, wherein the mechanism for measuring the arch height comprise s two opposing wedges movable towards and away from the arch of a foot and indicia associated with each wedge indicating the height of the arch based upon the position of the wedge.

25. A device for measuring foot size comprising:
a housing for receiving a foot;
a first reference for indicating a selected location of the back of a foot;
a second reference for indicating a selected location for one side of the right foot;
a third reference for indicating a selected location for one side of the left foot;
first indicia for indicating the length of a foot having the back of the foot at the first reference;
second indicia for indicating the width of the right foot having the one side thereof at the second reference;
third indicia for indicating the width of the left foot having the one side thereof at the third reference;
a plurality of scanners for scanning an image of the indicia and of the foot in the housing in three dimensions including the arch height thereof and a mechanism for measuring the length and width of the foot using the indicia and measuring the height of the arch of the foot.

26. The device according to claim 25, wherein the second and third indicia each comprise three parallel lines.

27. The device according to claim 25, wherein the scanners comprise CCD imagers.

28. The device according to claim 25, further comprising a processor for receiving the imaging information from the scanners and for producing the measurements.

29. The device according to claim 25, further comprising a modeler connected to the processor for forming orthotics customized to the measurements for each foot.
